(19) United States
(12) Patent Application Publication
(10) Pub. No.: US 2018/0090944 A1
(43) Pub. Date: Mar. 29, 2018

(54) CHARGER-CONVERTER WITH SINGLE INDUCTOR AND DOWNSTREAM LOW-DROPOUT REGULATOR

(71) Applicant: Apple Inc., Cupertino, CA (US)

(72) Inventors: Salvatore REDDICONTO, San Jose, CA (US); Dong YANG, Milpitas, CA (US)

(21) Appl. No.: 15/421,199

(22) Filed: Jan. 31, 2017

Related U.S. Application Data
(60) Provisional application No. 62/398,795, filed on Sep. 23, 2016.

(51) Int. Cl. H02J 7/00; G05F 1/575

(52) U.S. Cl. CPC H02J 7/007; G05F 1/575

(57) ABSTRACT

A charger-converter circuit in an electronic device detects whether an external power supply is coupled to the electronic device. The charger-converter circuit uses an inductor in an inductor-switch circuit to economize on volume occupied by the charger-converter circuit. The charger-converter circuit includes a low drop out voltage regulator (LDO) to provide, in each of three modes, a regulated supply voltage to a circuit module in the electronic device. When an external power supply is present, the charger-converter circuit charges a battery of the electronic device and operates in a buck mode or in a boost mode. When an external power supply is not present, the charger-converter circuit operates in a second buck mode. A pulse skipping technique may be applied to the inductor-switch circuit in the buck mode.

### BENEFIT CLAIM

This application claims the benefit of U.S. Provisional Patent Application No. 62/398,795 entitled “CHARGER-CONVERTER WITH SINGLE INDUCTOR AND DOWNSTREAM LOW-DROPOUT REGULATOR” filed on Sep. 23, 2016, which is hereby incorporated by reference.

### FIELD

The described embodiments are directed towards an inductor circuit with a low dropout voltage regulator for providing a buck mode when no input power source is present and providing buck and boost modes when an input power source is present.

### BACKGROUND

A conventional consumer electronics device includes integrated circuits having a buck converter for operation from an internal battery and a separate buck-boost charger for charging of the internal battery when an external power source is available. These integrated circuits include many components and switches which consume power and occupy important spatial volume within the consumer device. The inclusion of one inductor dedicated to a buck converter and a second inductor dedicated to a buck-boost charger significantly increases the circuit volume required. As consumer electronic devices become smaller in size, there is a need for integrated circuits to have reduced topology while also achieving energy efficiency.

### SUMMARY

This application describes various embodiments related to a bi-directional converter and techniques for operating the bi-directional converter in a charging mode and in a discharging mode.

A charger-converter circuit in an electronic device detects whether an external power supply is coupled to the electronic device. The charger-converter circuit may also be referred to herein as a charger-converter. The charger-converter circuit uses a single inductor in an inductor-switch circuit to economize on volume occupied by the charger-converter circuit. The charger-converter circuit includes a low dropout voltage regulator (LDO) to provide, in each of three modes, a regulated supply voltage to a circuit module in the electronic device. When an external power supply is present, the charger-converter circuit charges a battery of the electronic device by operating in a buck mode (if a battery voltage of the electronic device is below a voltage of the external power supply), or a boost mode. When an external power supply is not present, the charger-converter circuit operates in a second buck mode. A pulse skipping technique may be applied to the inductor-switch circuit in the second buck mode. The described embodiments may be better understood by reference to the following description and the accompanying drawings.

### BRIEF DESCRIPTION OF THE DRAWINGS

The disclosure will be readily understood by the following detailed description in conjunction with the accompanying drawings, wherein like reference numerals designate like structural elements.

FIG. 1A illustrates an exemplary electronic device comprising a charger-converter circuit and a battery, according to some embodiments.

FIG. 1B illustrates exemplary voltage comparisons, according to some embodiments.

FIG. 2A illustrates exemplary modes of the charger-converter circuit, according to some embodiments. The modes include a charging boost mode when an external power supply is present, a charging buck mode when the external power supply is present, and a discharging buck mode when no external power supply is present.

FIG. 2B illustrates exemplary waveforms when a power supply becomes attached to the electronic device and then is removed, according to some embodiments.

FIG. 2C illustrates exemplary logic for determining a mode in which to operate the charger-converter circuit, according to some embodiments.

FIG. 3A illustrates further details of the electronic device and the charger-converter circuit including an inductor-switch circuit, according to some embodiments.

FIG. 3B illustrates an exemplary implementation of a switch using a field effect transistor (FET), according to some embodiments.

FIG. 3C illustrates an exemplary power path switch, according to some embodiments.

FIG. 3D illustrates an exemplary reverse voltage protection (RVP) circuit, according to some embodiments.

FIG. 4 illustrates further details of the inductor-switch circuit, according to some embodiments. FIG. 4 includes labels for circuit elements such as switches and diodes and labels for circuit responses such as currents and voltages.

FIG. 5A illustrates exemplary behavior of the inductor-switch circuit while charging the battery in the boost mode, according to some embodiments. FIG. 5B illustrates exemplary switch control waveforms for FIG. 5A and the corresponding inductor current waveform versus time, according to some embodiments.

FIG. 6A illustrates exemplary behavior of the inductor-switch circuit while charging the battery in a buck mode, according to some embodiments. FIG. 6B illustrates exemplary switch control waveforms for FIG. 6A and the corresponding inductor current waveform versus time, according to some embodiments.

FIG. 7A illustrates exemplary behavior of the inductor-switch circuit while discharging the battery in a buck mode, according to some embodiments. FIG. 7B illustrates exemplary switch control waveforms for FIG. 7A and the corresponding inductor current waveform versus time, according to some embodiments.

Those skilled in the art will appreciate and understand that, according to common practice, various features of the drawings discussed below are not necessarily drawn to scale, and that dimensions of various features and elements of the drawings may be expanded or reduced to more clearly illustrate the embodiments of the present invention described herein.

### DETAILED DESCRIPTION

The following disclosure describes various embodiments of a single-stage, bi-directional converter and techniques for operating the single-stage, bi-directional converter. Certain details are set forth in the following description and figures to provide a thorough understanding of various embodiments of the present technology. Moreover, various features, structures, and/or characteristics of the present technology can be combined in other suitable structures and environments. In other instances, well-known structures, materials, operations, and/or systems are not shown or described in detail in the following disclosure to avoid unnecessarily obscuring the description of the various embodiments of the technology. Those of ordinary skill in the art will recognize, however, that the present technology can be practiced without one or more of the details set forth herein, or with other structures, methods, components, and so forth.

A charger may be required to charge a lithium battery using a power source that can also be another lithium battery. In some embodiments, a regulated voltage to supply a microcontroller unit (MCU) at the same time is also needed. When there is no external power supply, energy efficiency is very important to conserve battery life. In embodiments provided herein, an inductor is used both for charging circuits in which the input voltage is sometimes greater and sometimes less than the battery voltage and also used for a battery discharging buck configuration.

When no power supply is present, and for instances when the MCU power consumption is low, pulse skipping in the control waveforms driving switches in an inductor-switching circuit can be used to save power at the cost of increasing ripple in the resulting voltage waveform. The LDO takes care of filtering this ripple. An LDO is a regulator that can regulate an output voltage even when a supply voltage input to the LDO is very close to the output voltage. The control waveforms are used to provide, to the LDO, a voltage higher than the desired MCU voltage plus the LDO drop-out voltage at the maximum expected load. Efficiency with this circuit topology in the discharge mode may be about 90%. An example of 90% efficiency is as follows, for 1 Watt of power input to the circuit, 0.9 Watt is delivered at the output of the circuit. When the power supply is present and the difference between the input voltage and the output voltage of the LDO is higher, the efficiency of this circuit topology is less. However, when the (external) power supply is present, efficiency is not critical.

### System

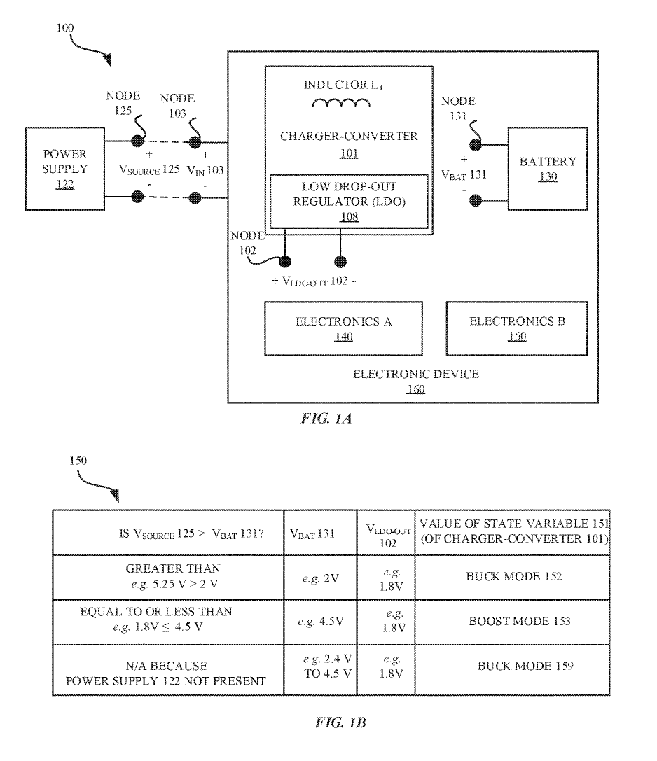

FIG. 1A illustrates a system 100 including an electronic device 160. The electronic device 160 comprises a charger-converter 101, an LDO 108, a battery 130, a module denoted electronics A (140), and a module denoted electronics B (150). Electronics B 150 is able to operate at the voltage V_{BAT}. In this description, when there is no risk of ambiguity, reference numerals may not always be provided or referred to. A power supply 122 may also be present. The charger-converter 101 includes an inductor L₁. When node 125 of the power supply 122 is coupled to node 103 of the electronic device 160, then V_{IN} 103 takes on the value V_{SOURCE} 125. The charger-converter 101 provided herein is configured to charge the battery 130 using energy from the power supply 122 when the power supply 122 is present.

V_{SOURCE} may be greater than or less than V_{BAT}. When V_{SOURCE} is greater, then the charger-converter 101 uses a buck mode of charging. When V_{SOURCE} is lesser, the charger-converter 101 uses a boost mode. Electronics A requires a regulated voltage, and this is supplied by LDO 108 whether the power supply 122 is present or not. Electronic device 160 may be quite small, and charger-converter 101 is designed to occupy a minimum of spatial volume by using, in some embodiments, the single inductor L₁. Also, energy efficiency is important for the performance of the electronic device 160. By using the single inductor L₁ and the LDO 108, the charger-converter 101 is able to supply power to electronics A 140 through the circuit including L₁ and through the LDO 108 whether the origin of the power is the power supply 122 or the battery 130.

FIG. 1B illustrates some exemplary comparisons between V_{SOURCE} and V_{BAT}. If the power supply 122 is present and provides a voltage greater than V_{BAT}, then a state variable 151 of the charger-converter 101 takes on a value indicating buck mode 152. If the power supply 122 is present and provides a voltage not greater than V_{BAT}, then the state variable 151 of the charger-converter 101 takes on a value indicating boost mode 153. If the power supply 122 is not present, then the state variable 151 of the charger-converter 101 takes on a value indicating buck mode 159.

### Charger-Converter Modes

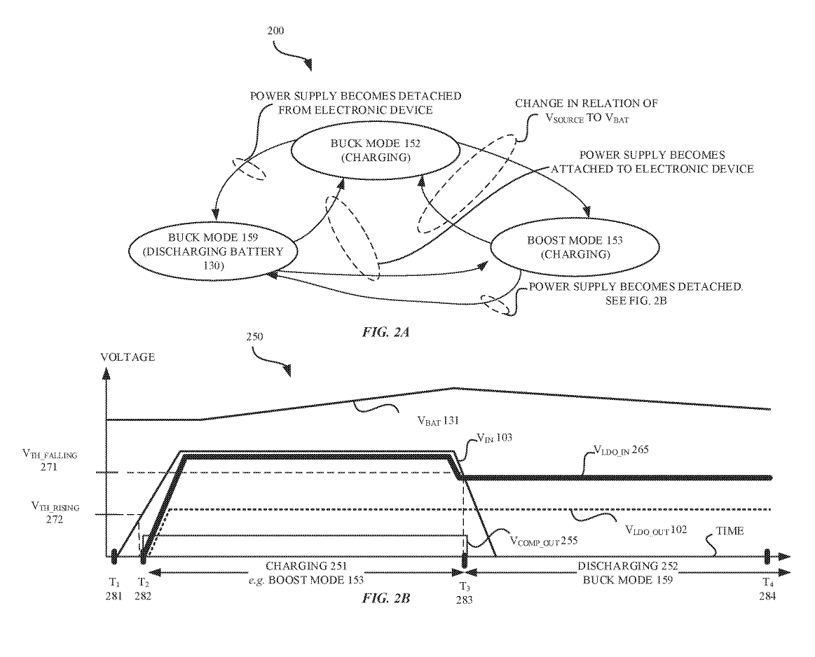

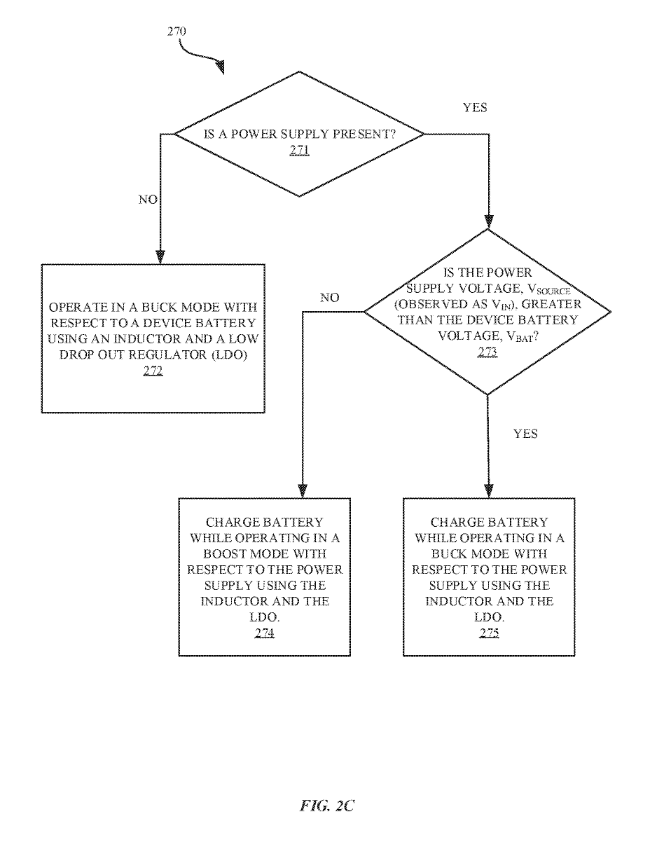

FIG. 2A illustrates a state diagram 200 of the charger-converter 101. The state variable 151 can take on a value indicating buck mode 152 (charging), boost mode 153 (charging), or buck mode 159 (discharging). Transitions between states will occur if the power supply becomes coupled to the input (node 103) of the electronics device 101 or the power supply becomes removed or if the charger-converter 101 is in a charging mode and the relation of V_{SOURCE} to V_{BAT} changes.

### Example Voltage Waveforms

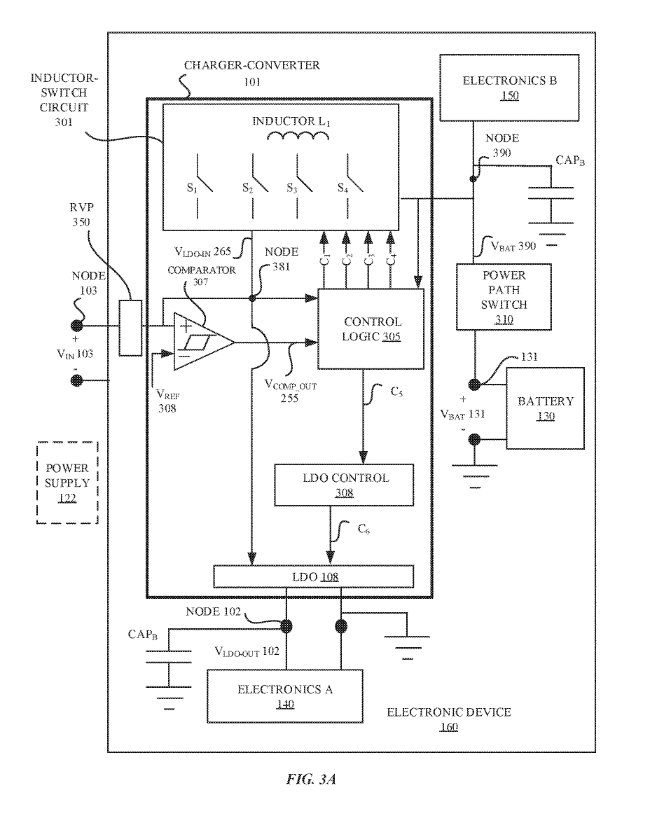

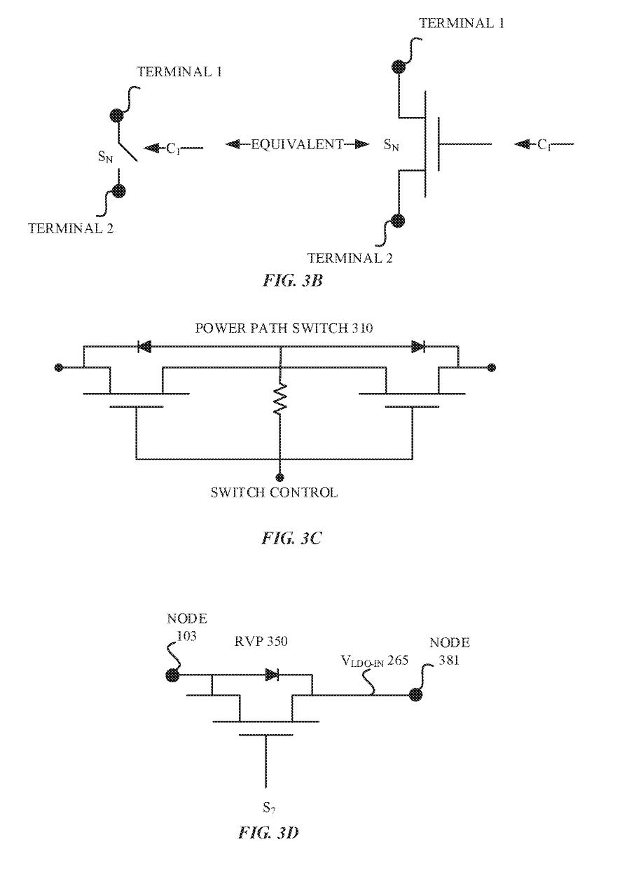

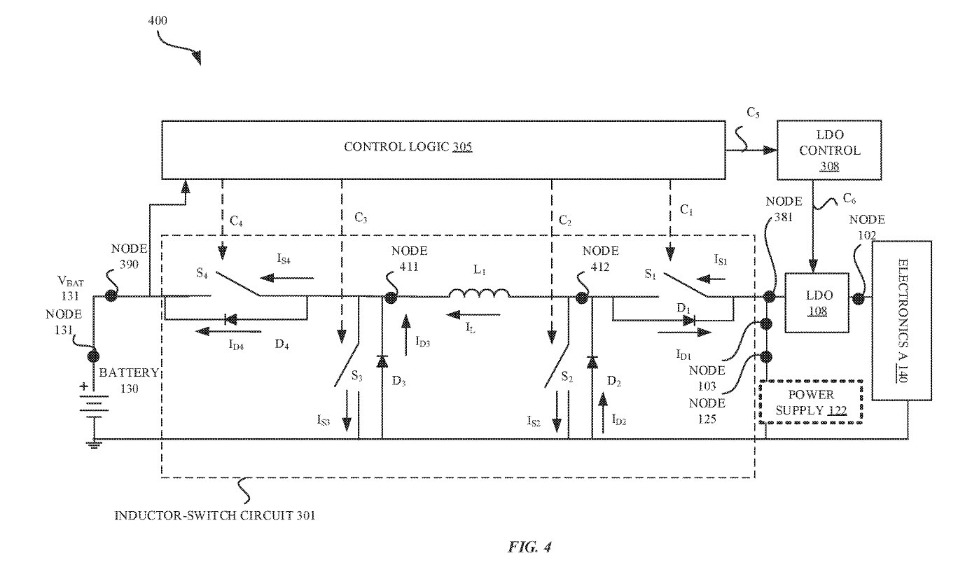

FIG. 2B provides illustrative waveforms corresponding to the power supply 122 becoming attached to node 103 at a time T₁ 281 and then removed at approximately a time T₃ 283. Five waveforms are shown: i) V_{BAT} 131, ii) V_{IN} 103, iii) V_{LDO}_{_}_{IN} 265 iv) V_{LDO}_{_}_{OUT} 102, and v) V_{COMP}_{_}_{OUT} 255. Circuit context for these voltages can be found in FIG. 3A, discussed below. The interval from T₂ 282 to T₃ 283 is denoted charging 251 and corresponds to operation in boost mode 153. The interval after T₃ is denoted discharging 252 and corresponds to operation in buck mode 159 (no particular end time to this exemplary interval is shown).

Before T₁, no power supply is attached and V_{BAT} is at some initial voltage (please see FIG. 2B). At T₁, the power supply 122 becomes attached and V_{IN} 103 begins to rise. A comparator 307 is used to detect the presence of the power supply at the node 103 (see FIG. 3A). The comparator exhibits hysteresis. The comparator is characterized by a threshold useful for detecting a rising edge (V_{TH}_{_}_{RISING} 272) and a higher threshold to detect a falling edge (V_{TH}_{_}_{FALLING} 271). As V_{IN} rises, it crosses V_{TH}_{_}_{RISING} at the time T₂. V_{COMP}_{_}_{OUT} takes on a logical one value (meaning, e.g., “TRUE”) and the charger-converter 101 begins operation in boost mode 153 including charging the battery 130. It is boost mode because, in this example, V_{IN}<V_{BAT}. V_{LDO}_{_}_{IN} (shown as a heavy bold line) follows V_{IN}. The charger-converter uses the input voltage V_{IN} and the inductor L₁ to charge the battery and V_{BAT} begins to rise. V_{LDO}_{_}_{OUT}, the input to electronics A 140, is shown as fine dotted line. The LDO 108 regulates V_{LDO}_{_}_{IN} and produces the value V_{LDO}_{_}_{OUT}.

At about the time T₃, the power supply 122 is removed, and V_{COMP}_{_}_{OUT} drops to a logical zero value (meaning, e.g., “FALSE”) and the charger-converter enters the state buck mode 159. At T₃, V_{IN} declines to zero. V_{LDO}_{_}_{IN} becomes dependent on V_{BAT}. V_{BAT} of FIG. 2B begins to decline. V_{LDO}_{_}_{OUT}, based on LDO 108, holds steady. The waveforms illustrate mode events and are not drawn to scale.

### Logic to Determine Mode

FIG. 2C illustrates exemplary logic 270 for operation of the charger-converter 101. At 271, presence or absence of an external power supply is detected. If an external power supply is not present, the charger-converter 101 operates in a first buck mode (at 272) using an inductor and an LDO. If an external power supply is present, the logic flows from 271 to 273. At 273, the logic determines whether V_{IN}>V_{BAT} or not. If V_{IN}>V_{BAT}, then the logic flows to 275 and the charger-converter operates in a second buck mode using the same inductor and LDO as in the first buck mode. Otherwise, the logic flows to 274 and the charger-converter operates in a boost mode using the same inductor and LDO.

### Details of the Electronic Device and of the Charger-Converter

FIG. 3A illustrates further details of the electronic device 101 and the charger-converter 101. The battery 130 is coupled through a power path switch 310. Details of the power path switch 310 are given in FIG. 3C. Node 103 is coupled to the charger-converter 101 through a reverse voltage protection (RVP) block 350. An example RVP block is illustrated in FIG. 3D. The charger-converter 101 includes: i) inductor-switch circuit 301, ii) control logic 305, iii) comparator 307, iv) LDO control 308, and v) LDO 108. The inductor-switch circuit 301 includes four switches: S₁, . . . , S₄. The four switches are controlled by the four control signals C₁, . . . , C₄, respectively (provided by the control logic 305). The inductor switch circuit is coupled to: i) the battery by nodes 131 and 390 and ii) the input port or node 103 by node 381.

The comparator 307 compares the value of V_{IN} 103 to a reference V_{REF} 308. The output, V_{COMP}_{_}_{OUT} 255, is an input to the control logic 305. Control logic 108 sends a signal C₅ to enable the LDO control 308. The LDO control 308 enables the LDO 108 with the signal C₆. The input power to the LDO arrives from the node 381, which is coupled both to the charger-converter circuit 101 and to the input port, node 103.

In FIG. 3A, power supply 122 is shown with a dashed outline because it may or may not be present.

Exemplary voltages and comments are provided in Table 1. V_{SYS} refers to the voltage acceptable to electronics B 150. The term “rail” refers to a conductor in a circuit carrying a supply voltage.

TABLE 1
Exemplary voltages in some embodiments.

| Entity/Voltage | Voltage Characteristic |
|---|---|
| V_{BAT} 131 | In charge mode: 1.5 V to 4.5 V; in discharge |
| | mode: 2.4 V to 4.5 V. |
| V_{IN} 103 | 2.5 V to 5.25 V. |
| V_{SYS} | 2.4 V to 4.5 V (Electronics B includes system |
| | blocks that can run at V_{BAT}). |
| V_{LDO}_{_{—}}_{OUT} 102 | Highest power system rail requiring regulated |
| | rail less than minimum (V_{IN}) − V_{LDO DROPOUT} |
| V_{RISING} | Rising edge threshold for the comparator 307. |
| V_{FALLING} | Falling edge threshold for the comparator 307. |

### Inductor-Switch Circuit

FIG. 4 provides further details of the inductor-switch circuit 301 in connection with other components of the system 100. Power supply 122 is again shown as a dashed box because it may or may not be present. Inductor-switch circuit 301 is shown with a dashed outline to indicate the components within it. C₁, C₂, C₃, and C₄ (introduced in FIG. 3A) are switch control signals coming from control logic 305 and controlling S₁, S₂, S₃, and S₄, respectively. An exemplary implementation of a switch S_{N} is provided in FIG. 3B (where N may be 1, 2, 3, or 4, for example).

FIG. 4 illustrates the circuit components and circuit responses or signals of the inductor-switch circuit 301 while operating electronics A 140 through the LDO 108 using the inductor L₁, according to some embodiments. The control signals, C₁, . . . , C₄ depend on whether the power supply 122 is present, and, if so, on whether the power supply voltage (V_{SOURCE}) is higher or lower than the battery voltage (V_{BAT}). If the power supply 122 is present, the control sequences correspond to operation in buck mode 152 or in boost mode 153. In addition, LDO 108 and the inductor L₁ are again used in the same circuit with different control signals to operate in buck mode 159 when no external power supply is present. In this way, the electronics A 140 is operated, and the battery 130 is charged (when power is available), all using the same charger-converter 101 but with different control signal sets for each of the three modes. In FIG. 2A, state variable 151 is illustrated as exhibiting one of three different states or modes.

FIG. 4 illustrates diodes D₁, D₂, D₃, and D₄ in parallel with the switches S₁, S₂, S₃, and S₄. The anode terminals of D₃ and D₂ are connected to a ground node. The terminals of L₁ are connected to nodes denoted node 411 and node 412. The anode terminals of D₄ and D₁ are connected to node 411, and node 412, respectively. The cathode terminals of D₄ and D₁ are connected to nodes 390 and node 381, respectively (introduced in FIG. 3). Some circuit components are modelled as ideal, so the power path switch 310 is not shown and the RVP 350 is not shown.

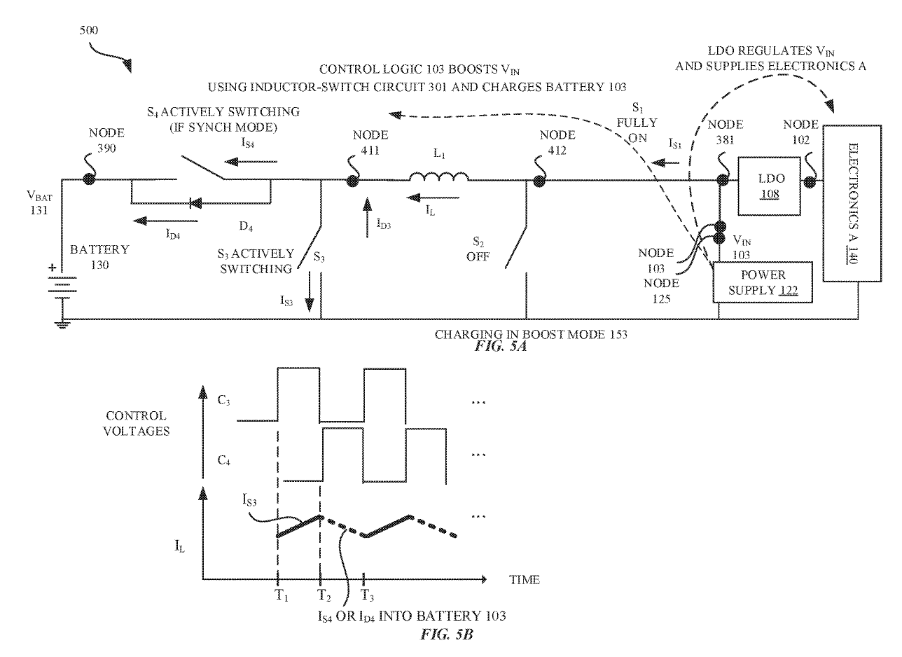

The topology of FIG. 4 provides the LDO 108 with access to both the input port 103 and to the battery 130. The topology design places the inductor L₁ in a central circuit location so that L₁ can be used for each of the three modes, as illustrated in the circuit drawings of FIGS. 5A, 6A, and 7A, and the inductor L₁ current waveforms of FIGS. 5B, 6B, and 7B.

### Inductor-Switch Circuit, Boost Mode 153 (Charging)

FIG. 5A illustrates the configuration of the inductor-switch circuit 301 in boost mode 153. Reference is made to times T₁, T₂, and T₃ of FIG. 5B. Generally, the described events repeat periodically as indicated by the ellipses ( . . . ) in FIG. 5B. S₁ is fully (i.e., continuously) on. S₂ is continuously off. S₃ is actively switching based on C₃, i.e., becoming on (closed) at time T₁, becoming off (open) at time T₂, etc. (see FIG. 5B). S₄, in some embodiments, synchronously switches off when S₃ switches on at time T₃, and vice-versa. Alternatively, S₄ is off continuously and charging current flows as I_{D4} when S₃ transitions to an off state at time T₂. One dashed arrow annotation illustrates that the LDO 108 regulates V_{IN} and supplies power to electronics A. The second dashed arrow annotation illustrates that the power supply 120 charges the battery 130 while the inductor-switch circuit 301 operates in boost mode 153. Example voltage waveforms for boost mode 153 are shown in FIG. 2B during an interval labelled charging 251.

FIG. 5B illustrates switch control waveforms and the components of the current I_{L} in boost mode 153. When C₃ is asserted (shown as a high value) starting at the time T₁, S₃ closes and the power supply 122 voltage at node 412 begins to drive a current I_{L} through L₁. Thus, S₃ being closed permits a current driven (or caused or induced) by the power supply 122 to flow through the inductor L₁. According to the behavior of inductors, v(t)=L di(t)/dt and so I_{L} does not change instantaneously. As I_{L} ramps or builds between times T₁ and T₂, a magnetic field builds up in the windings of the inductor L₁. This ramping current passes through the closed switch S₃ to ground (according to the current equation at node 411, I_{L}=I_{S3}, D₄ is reverse biased and S₄ is open) as shown in FIG. 5B with a heavy line for I_{L} during the time T₁ to time T₂. If C₄ is actively switching, then when S₃ opens at T₂, S₄ (as controlled by C₄) closes as shown in FIG. 5B; this is called synchronous mode, abbreviated as synch mode in the figures. The magnetic field in the windings of the inductor L₁ begins to collapse at time T₂ and the current I_{L} now equals I_{S4} according to the current equation at the node 411. The collapsing current may be referred to as a transient current. This transient portion of the I_{L} waveform is shown as a heavy dashed line in FIG. 5B from time T₂ to time T₃.

In some embodiments, the heavy dashed line represents current flow through D₄ if S₄ is not actively switching. In that case (not synch mode), C₄ is fully or continuously off (i.e. continuously unasserted in boost mode 153) and so S₄ is continuously open; a realization of the signal C₄ is not illustrated in FIG. 5B for the continuously-off case.

The heavy dashed line in FIG. 5B charges the battery 130 from T₂ to T₃. Because the second pulse of C₃ (starting at T₃) occurs before the I_{L} waveform has reached zero, the current I_{L} begins to ramp up again at T₃ rather than decaying to zero. A repeated rippling wave of I_{L} results as illustrated in FIG. 5B as long as C₃ (and, in some embodiments, C₄) pulses continue to occur.

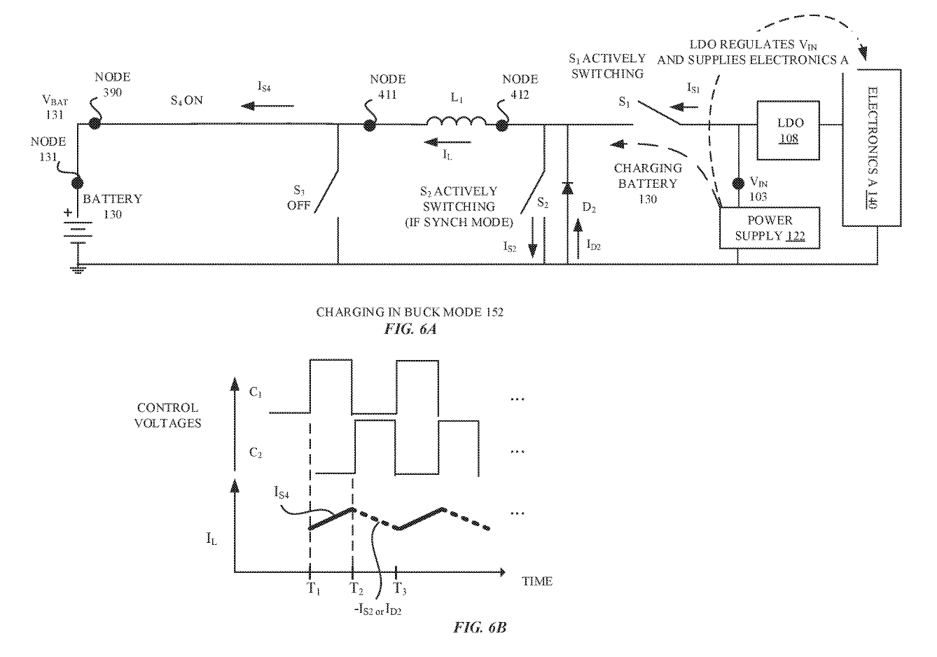

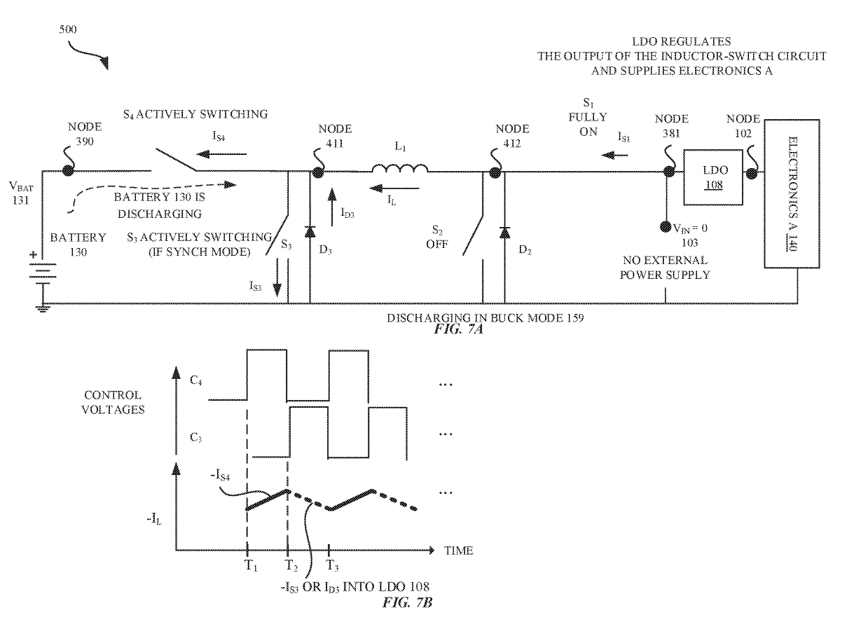

FIGS. 6A and 7A are similar in form to FIG. 5A. FIGS. 6B and 7B are similar in form to FIG. 5B. The description of FIGS. 6A, 6B, 7A, and 7B is written with this in mind.

### Inductor-Switch Circuit, Buck Mode 152 (Charging)

FIG. 6A illustrates charging in buck mode 152. Power supply 122 is present and has a higher voltage than the battery 130. The power supply 122 provides power to the electronics A 140 through the LDO 108. S₁ is actively switching (see times T₁, T₂, and T₃ in FIG. 6B), S₄ is continuously on (closed), and S₃ is continuously off (open). As for FIGS. 5A and 5B, “fully” and “continuously” mean the switch is simply commanded to take a value and then the value does not change while the circuit is in the particular mode, in this case buck mode 152. Like FIG. 6A, FIG. 6B pertains to buck mode 152. As shown in FIG. 6B, when S₁ closes at time T₁, I_{L} ramps up. I_{L} is equal to I_{S4} based on the current equation at the node 411. In synch mode, when C₁ goes to 0 at time T_{z}, C₂ becomes asserted as shown in FIG. 6B. Current then flows from time T₂ to T₃ through S₂, through L₁, through S₄, and into the battery 130, charging it. This current continues to flow because of the magnetic field in L₁. However, the energy in L₁ is declining and so does I_{L}, until the next pulse occurs on C₁. The current IL may be referred to as a transient current from time T₂ to T₃.

### Inductor-Switch Circuit, Buck Mode 159 (Discharge)

FIG. 7A illustrates operation of the inductor-switch circuit 301 for the case in which the power supply 122 is absent. The control logic 305 then operates the inductor-switch circuit 301 in buck mode 159. Example voltage waveforms for buck mode 159 are shown in FIG. 2B for an interval labelled discharging 252. The same inductor-switch circuit 301 that was used for charging with various power supply voltage levels while the power supply fed the electronics A 140 through the LDO 108 is now used for powering electronics A 140 (again through the LDO 108) from the battery 130. Thus, the inductor-switch circuit 301 supports a flow of power in either direction while using a small number of circuit components, particularly using a single inductor.

In buck mode 159, the battery voltage is now the only available supply for Electronics A 140, i.e., no external power supply is present. The Control logic of the Buck converter regulates its output voltage at the required supply voltage for A 140, plus some margin for LDO drop-out. The LDO will work with a minimum possible drop-out in order to still guarantee a clean regulated supply for Electronics A 140, while reducing the power losses. S₁ is continuously on (closed), S₂ is continuously off (open), and S₄ is actively switching. In synch mode, S₃ switches to closed state each time S₄ switches to an open state (e.g., at time T₂), and vice-versa. When S₄ is closed, current flows from left to right in the figure, so I_{L} is negative based on the I_{L} arrow being oriented right to left in FIG. 7A. In FIG. 7B, the ordinate (also referred to as y-axis or vertical axis) is labelled −I_{L} and the corresponding current intensity is shown as positive. Like FIG. 7A, FIG. 7B pertains to buck mode 159. When S₄ is closed at time T₁, current builds up in L₁ flowing from the battery 130 toward the LDO 108. This is a battery-discharging current. The current builds up a magnetic field in L₁ from time T₁ to time T₂. When S₄ opens and S₃ closes at time T₂, the current through the inductor L₁ continues to flow (shown as a heavy dashed line), but in decline as the magnetic field collapses. If the switch S₃ is not used in synch mode, then I_{D3} flows when S₄ opens at time T₂.

The pulses of C₄ in FIG. 7B generally continue to repeat to form a periodic train while in buck mode 159. This is indicated by an ellipsis (“ . . . ”). In some embodiments, a pulse may be purposefully dropped by the control logic 305 from the control signal C₄. This may be referred to as pulse skipping (not shown in FIG. 7B). Consider a pulse-skipping case in which the pulse on C₄ which begins at T₃ is instead skipped. The corresponding heavy dashed line representing −I_{L} will then decay further toward zero after T₃ before the next pulse of C₄ occurs, and permits the battery 130 to drive −I_{S4} into L₁. Although pulse skipping increases the ripple on V_{LDO-IN} 265 (at node 381), some battery energy savings can be achieved. The LDO will take care to filter the higher ripple at the output of the Buck working in pulse skipping mode. This mode of operation improves efficiency while keeping the supply to Electronics A 140 as clean as possible from switching noise and other disturbances. In this case the Buck output voltage (V_{LDO-IN} 265) will be regulated at a voltage level that takes into account the minimum drop-out allowed by the LDO for proper regulation and also the ripple generated by the pulse skipping mode.

Thus, a single inductor and LDO serve the purposes of charging a battery when an external power supply is attached while supplying energy to an electronics module for various external power supply levels. The same single inductor circuit is used for providing power to the electronics module through the same LDO when an external power supply is not attached. Redundant circuit components are avoided and space is saved.

This disclosure describes an electronic device comprising a battery, a first electronics module, an input port, and a charger-converter circuit. In some embodiments, the charger-converter circuit includes an inductor-switch circuit, a comparator, an LDO, and control logic. In some embodiments, the control logic is configured to determine, using a detection result from the comparator, whether an external power supply is present at the input port, operate the inductor-switch circuit in a first buck mode to supply power to the first electronics module via the LDO when the detection result indicates no external power supply is present, and operate the inductor-switch circuit in a second buck mode or in a boost mode to supply power to the first electronics module via the LDO when the detection result indicates an external power supply is present.

In some embodiments, the electronic device includes a second electronics module coupled to the battery.

In some embodiments, the inductor-switch circuit comprises an inductor comprising a first terminal and a second terminal, a first switch, controlled by the control logic, coupled between the first terminal and an input of the LDO, a second switch, controlled by the control logic, coupled from the first terminal to a ground node, a third switch, controlled by the control logic, coupled from the second terminal to the ground node, and a fourth switch, controlled by the control logic, coupled from the second terminal to the battery.

In some embodiments, the control logic of the electronic device is configured to determine, using a detection result from the comparator, whether an external power supply is present. In some embodiments of the electronic device, when the detection result indicates no external power supply is present, the control logic is further configured to place the first switch in a continuously-on state, place the second switch in a continuously-off state, and actively switch the fourth switch to permit a battery-driven current in the inductor. In some embodiments, the control logic is further configured to actively switch the third switch in synchronization with the fourth switch so that on-to-off transitions of the fourth switch correspond to off-to-on transitions of the third switch. In some embodiments, the control logic is further configured to place the third switch in a continuously-off state, whereby when the fourth switch is switched to an off state a transient current in the inductor is supplied via a third diode, wherein: i) the third diode is in parallel with the third switch, and ii) an anode terminal of the third diode is coupled to the ground node.

In some embodiments, the control logic of the electronic device is configured to determine, using a detection result from the comparator, whether an external power supply is present. In some embodiments of the electronic device, when the detection result indicates no external power supply is present, the control logic is further configured to actively switch the fourth switch by not sending a particular control pulse to the fourth switch at a first time in order to conserve power in the battery. A ripple in a voltage coupled to the LDO is caused by an absence of the particular control pulse at the first time, and the LDO reduces an energy of the ripple at an input to the first electronics module.

In some embodiments, the control logic of the electronic device is configured to determine, using a detection result from the comparator, whether an external power supply is present. In some embodiments of the electronic device, when the detection result indicates an external power supply is present and a voltage of the external power supply exceeds a voltage of the battery, the control logic is further configured to place the fourth switch in a continuously-on state, place the third switch in a continuously-off state, and actively switch the first switch to repeatedly permit a supply-driven current in the inductor. In some embodiments of the electronic device, the control logic is further configured to actively switch the second switch in synchronization with the first switch so that on-to-off transitions of the first switch correspond to off-to-on transitions of the second switch. In some embodiments of the electronic device, the control logic is further configured to place the second switch in a continuously-off state, whereby when the first switch is switched to an off state a transient current in the inductor is supplied via a second diode, wherein: i) the second diode is in parallel with the second switch, and ii) an anode terminal of the second diode is coupled to the ground node.

In some embodiments, the control logic of the electronic device is configured to determine, using a detection result from the comparator, whether an external power supply is present. In some embodiments of the electronic device, when the detection result indicates an external power supply is present and a voltage of the battery exceeds a voltage of the power supply, the control logic is further configured to: actively switch the third switch to permit a supply-driven current in the inductor, place the first switch in a continuously-on state, and place the second switch in an continuously-off state. In some embodiments, the control logic is further configured to actively switch the second switch in synchronization with the first switch so that on-to-off transitions of the first switch correspond to off-to-on transitions of the second switch. In some embodiments, the control logic is further configured to place the fourth switch in a continuously-off state, whereby when the third switch is switched to an off state a transient current in the inductor is supplied via a fourth diode, wherein: i) the fourth diode is in parallel with the fourth switch, and ii) an anode terminal of the fourth diode is coupled to the ground node.

This application discloses a charger-converter circuit, comprising an inductor-switch circuit, a comparator, a low drop out voltage regulator (LDO), and control logic, wherein the control logic is configured to: i) determine, using a detection result from a comparator, whether an external power supply is present at an input port of an electronic device, ii) operate the inductor-switch circuit in a first buck mode to supply power to a first electronics module of the electronic device via the LDO when the detection result indicates no external power supply is present, and iii) operate the inductor-switch circuit in a second buck mode or in a boost mode to supply power to the first electronics module via the LDO when the detection result indicates an external power supply is present.

In some embodiments, the inductor-switch circuit comprises: an inductor comprising a first terminal and a second terminal; a first switch, controlled by the control logic, coupled between the first terminal and an input of the LDO; a second switch, controlled by the control logic, coupled from the first terminal to a ground node; a third switch, controlled by the control logic, coupled from the second terminal to the ground node; and a fourth switch, controlled by the control logic, coupled from the second terminal to a battery of the electronic device.

In some embodiments of the inductor-switch circuit when the detection result indicates no external power supply is present, the control logic is further configured to: place the first switch in a continuously-on state; place the second switch in an continuously-off state; and actively switch the fourth switch to repeatedly permit a battery-driven current in the inductor. In some embodiments, the control logic is further configured to actively switch the third switch in synchronization with the fourth switch so that on-to-off transitions of the fourth switch correspond to off-to-on transitions of the third switch. In some embodiments, the control logic is further configured to: place the third switch in a continuously-off state, whereby when the fourth switch is switched to an off state a transient current in the inductor is supplied via a third diode, wherein: i) the third diode is in parallel with the third switch, and ii) an anode terminal of the third diode is coupled to the ground node.

This application discloses an electronic device comprising: a battery; a first electronics module; an input port; and a charger-converter circuit, wherein: the charger-converter circuit comprises: i) an inductor-switch circuit comprising a single inductor, ii) a comparator, iii) a low drop out voltage regulator (LDO), and iv) control logic. The control logic of the electronic device is configured to: i) determine, using a detection result from the comparator, whether an external power supply is present at the input port, ii) operate the inductor-switch circuit in a first buck mode to supply power to the first electronics module via the LDO when the detection result indicates no external power supply is present, and iii) operate the inductor-switch circuit in a second buck mode or in a boost mode to supply power to the first electronics module via the LDO when the detection result indicates an external power supply is present.

The foregoing description is intended to enable any person skilled in the art to make and use the disclosure, and is provided in the context of a particular application and its requirements. Moreover, the foregoing descriptions of embodiments of the present disclosure have been presented for purposes of illustration and description only. They are not intended to be exhaustive or to limit the present disclosure to the forms disclosed. Accordingly, many modifications and variations will be apparent to practitioners skilled in the art, and the general principles defined herein may be applied to other embodiments and applications without departing from the spirit and scope of the present disclosure. Additionally, the discussion of the preceding embodiments is not intended to limit the present disclosure. Thus, the present disclosure is not intended to be limited to the embodiments shown, but is to be accorded the widest scope consistent with the principles and features disclosed herein.

What is claimed is:

1. An electronic device comprising:
a battery;
a first electronics module;
an input port; and
a charger-converter circuit, wherein:
1) the charger-converter circuit comprises:
i) an inductor-switch circuit,
ii) a comparator,
iii) a low drop out voltage regulator (LDO), and
iv) control logic, and
2) the control logic is configured to:
i) determine, using a detection result from the comparator, whether an external power supply is present at the input port,
ii) operate the inductor-switch circuit in a first buck mode to supply power to the first electronics module via the LDO when the detection result indicates no external power supply is present, and
iii) operate the inductor-switch circuit in a second buck mode or in a boost mode to supply power to the first electronics module via the LDO when the detection result indicates an external power supply is present.

2. The electronic device of claim 1, further comprising:
a second electronics module coupled to the battery.

3. The electronic device of claim 1, wherein the inductor-switch circuit comprises:
an inductor comprising a first terminal and a second terminal;
a first switch, controlled by the control logic, coupled between the first terminal and an input of the LDO;
a second switch, controlled by the control logic, coupled from the first terminal to a ground node;
a third switch, controlled by the control logic, coupled from the second terminal to the ground node; and
a fourth switch, controlled by the control logic, coupled from the second terminal to the battery.

4. The electronic device of claim 3, wherein, when the detection result indicates no external power supply is present, the control logic is further configured to:
place the first switch in a continuously-on state;
place the second switch in a continuously-off state; and
actively switch the fourth switch to permit flow of a battery-driven current in the inductor.

5. The electronic device of claim 4, wherein the control logic is further configured to:
actively switch the third switch in synchronization with the fourth switch so that on-to-off transitions of the fourth switch correspond to off-to-on transitions of the third switch.

6. The electronic device of claim 4, wherein the control logic is further configured to:
place the third switch in a continuously-off state, whereby when the fourth switch is switched to an off state a transient current in the inductor is supplied via a third diode, wherein: i) the third diode is in parallel with the third switch, and ii) an anode terminal of the third diode is coupled to the ground node.

7. The electronic device of claim 4, wherein the control logic is further configured to:
actively switch the fourth switch by not sending a particular control pulse to the fourth switch at a first time in order to conserve power in the battery.

8. The electronic device of claim 7, wherein i) a ripple in a voltage coupled to the LDO is caused by an absence of the particular control pulse at the first time, and ii) the LDO reduces an energy of the ripple at an input to the first electronics module.

9. The electronic device of claim 3, wherein, when the detection result indicates an external power supply is present and a voltage of the external power supply exceeds a voltage of the battery, the control logic is further configured to:
place the fourth switch in a continuously-on state;
place the third switch in a continuously-off state; and
actively switch the first switch to repeatedly permit flow of a supply-driven current in the inductor.

10. The electronic device of claim 9, wherein the control logic is further configured to:
actively switch the second switch in synchronization with the first switch so that on-to-off transitions of the first switch correspond to off-to-on transitions of the second switch.

11. The electronic device of claim 9, wherein the control logic is further configured to:
place the second switch in a continuously-off state, whereby when the first switch is switched to an off state a transient current in the inductor is supplied via a second diode, wherein: i) the second diode is in parallel with the second switch, and ii) an anode terminal of the second diode is coupled to the ground node.

12. The electronic device of claim 3, wherein, when the detection result indicates an external power supply is present and a voltage of the battery exceeds a voltage of the power supply, the control logic is further configured to:
actively switch the third switch to permit flow of a supply-driven current in the inductor;
place the first switch in a continuously-on state; and
place the second switch in an continuously-off state.

13. The electronic device of claim 12, wherein the control logic is further configured to:
actively switch the second switch in synchronization with the first switch so that on-to-off transitions of the first switch correspond to off-to-on transitions of the second switch.

14. The electronic device of claim 12, wherein the control logic is further configured to:
place the fourth switch in a continuously-off state, whereby when the third switch is switched to an off state a transient current in the inductor is supplied via a fourth diode, wherein: i) the fourth diode is in parallel with the fourth switch, and ii) an anode terminal of the fourth diode is coupled to the second terminal.

15. A charger-converter circuit, comprising:
an inductor-switch circuit;
a comparator;
a low drop out voltage regulator (LDO); and
control logic, wherein the control logic is configured to:
i) determine, using a detection result from a comparator, whether an external power supply is present at an input port of an electronic device,
ii) operate the inductor-switch circuit in a first buck mode to supply power to a first electronics module of the electronic device via the LDO when the detection result indicates no external power supply is present, and
iii) operate the inductor-switch circuit in a second buck mode or in a boost mode to supply power to the first electronics module via the LDO when the detection result indicates an external power supply is present.

16. The charger-converter circuit of claim 15, wherein the inductor-switch circuit comprises:
an inductor comprising a first terminal and a second terminal;
a first switch, controlled by the control logic, coupled between the first terminal and an input of the LDO;
a second switch, controlled by the control logic, coupled from the first terminal to a ground node;
a third switch, controlled by the control logic, coupled from the second terminal to the ground node; and
a fourth switch, controlled by the control logic, coupled from the second terminal to a battery of the electronic device.

17. The charger-converter circuit of claim 16, wherein, when the detection result indicates no external power supply is present, the control logic is further configured to:
place the first switch in a continuously-on state;
place the second switch in an continuously-off state; and
actively switch the fourth switch to repeatedly permit flow of a battery-driven current in the inductor.

18. The charger-converter circuit of claim 17, wherein the control logic is further configured to:
actively switch the third switch in synchronization with the fourth switch so that on-to-off transitions of the fourth switch correspond to off-to-on transitions of the third switch.

19. The charger-converter circuit of claim 17, wherein, the control logic is further configured to:
place the third switch in a continuously-off state, whereby when the fourth switch is switched to an off state a transient current in the inductor is supplied via a third diode, wherein: i) the third diode is in parallel with the third switch, and ii) an anode terminal of the third diode is coupled to the ground node.

20. An electronic device comprising:
a battery;
a first electronics module;
an input port; and
a charger-converter circuit, wherein:
1) the charger-converter circuit comprises:
i) an inductor-switch circuit comprising a single inductor,
ii) a comparator,
iii) a low drop out voltage regulator (LDO), and
iv) control logic, and
2) the control logic is configured to:
i) determine, using a detection result from the comparator, whether an external power supply is present at the input port,
ii) operate the inductor-switch circuit in a first buck mode to supply power to the first electronics module via the LDO when the detection result indicates no external power supply is present, and
iii) operate the inductor-switch circuit in a second buck mode or in a boost mode to supply power to the first electronics module via the LDO when the detection result indicates an external power supply is present.
